(19) United States
(12) Patent Application Publication
(10) Pub. No.: US 2008/0093411 A1
(43) Pub. Date: Apr. 24, 2008

(54) Air flow guide device for pneumatic tools

(76) Inventor: Min-Kai Chang, Taichung City (TW)

Correspondence Address: PHILLIP LIU, 6980, WHITEOAK DR., RICHMOND, BC, V7EAZ9, US

(21) Appl. No.: 11/498,238

(22) Filed: Aug. 3, 2006

(51) Int. Cl. B25C 1/04

(52) U.S. Cl. 227/130

(57) ABSTRACT

A pneumatic tool air flow guide device includes a barrel having a protrusion on a rear end thereof and a plurality of outlets are defined through the protrusion. The protrusion has a plurality of first flat sides on an outside thereof. A cap has a tube extending from a top thereof and the tube is rotatably connected to the protrusion. A hole is defined through the tube so that the air is ejected from the hole in the tube via the outlets. The tube has a plurality of second flat sides defined in an inside thereof and the second flat sides are engaged with the first flat sides.

### FIELD OF THE INVENTION

The present invention relates to an air flow guide device which has a cap rotatably connected to rear end of a barrel by engaging a polygonal tube on the cap with polygonal protrusion on the rear end of the barrel.

### BACKGROUND OF THE INVENTION

A conventional pneumatic tool such as a pneumatic staple gun or nail gun generally includes a barrel with a handle which is connected with a hose so as to introduce pressurized air into the barrel to eject staples or nails out from the nosepiece on a front end of the barrel. Due to reciprocating movement of the cylinder in the barrel, air flow is ejected out from a rear end of the barrel, and the air flow is strong enough to make the users feel uncomfortable. A guide cap is rotatably connected to the rear end of the barrel so that the air flow can be guided aside and not to blow directly toward the users. However, some of the guide caps do not have a proper positioning device so that the guide cap is rotatable by the air flows. In other words, the user cannot control the direction that the air flows eject. Some other guide cap has dents defined in an inside thereof and a boss extend from the rear end of the barrel so that the boss is engaged with one of the dents to position the guide cap. Nevertheless, the engagement between the boss and the dent is not secure enough to keep the guide cap at the desired position so that the guide cap may not be positioned at the desired position.

The present invention intends to provide an air flow guide device for pneumatic tools and the device includes a cap that has a polygonal tube which includes rounded portions which allow the cap to be rotatable on the polygonal protrusion on the rear end of the barrel.

### SUMMARY OF THE INVENTION

The present invention relates to a pneumatic tool air flow guide device and comprises a barrel having a protrusion on a rear end thereof and a plurality of outlets are defined through the protrusion. The protrusion has a plurality of first flat sides on an outside thereof. A cap is rotatably connected to the rear end of the barrel and has a tube which is rotatably mounted to the protrusion. A hole is defined through the tube and the tube has a plurality of second flat sides defined in an inside thereof. The second flat sides are engaged with the first flat sides.

The primary object of the present invention is to provide a air flow guide device for pneumatic tools wherein the cap is positioned on the protrusion on the rear end of the barrel and the cap is able to be rotated relative to the protrusion so that the user can set the desired direction for the air flow ejected from the barrel.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the air flow guide device of the present invention;

FIG. 2 is a perspective view to show the cap of the air flow guide device of the present invention;

FIG. 3 is a top cross sectional view to show that the tube on the cap is mounted to the protrusion on the barrel, and

FIG. 4 is a side cross sectional view to show that the tube is mounted to the protrusion on the barrel, and

FIGS. 5 and 6 show that the cap is rotated and positioned at two different angular positions.

### DETAILED DESCRIPTION OF THE PREFERRED EMBODIMENT

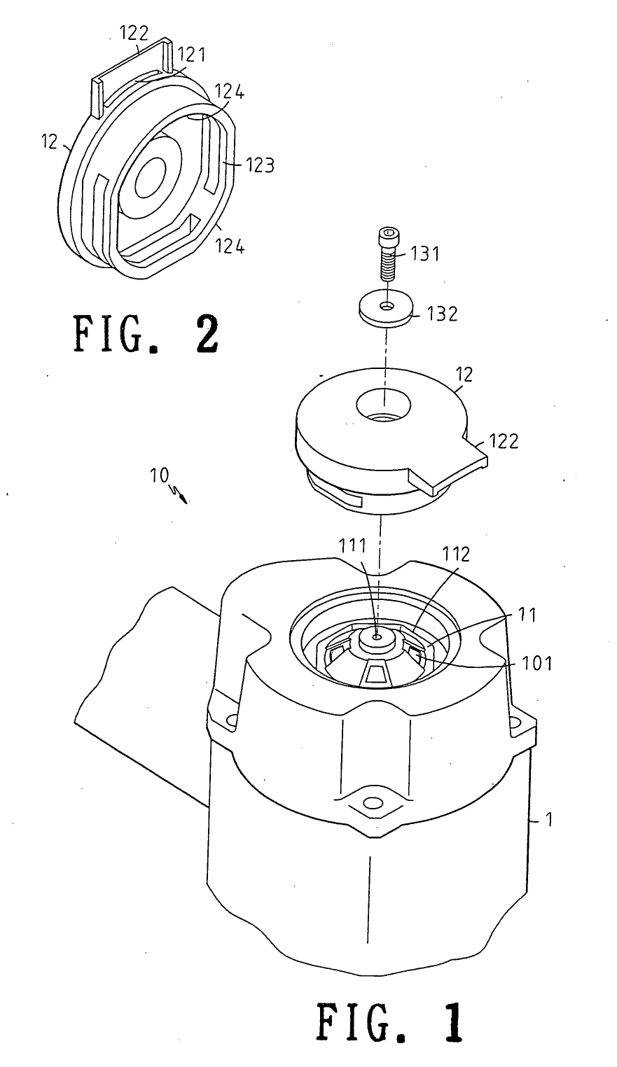

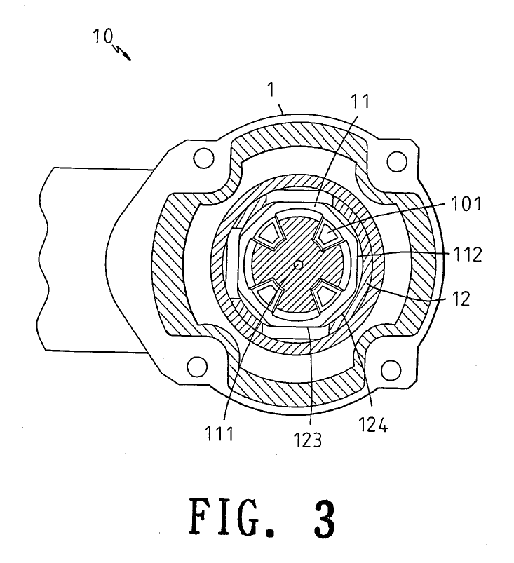

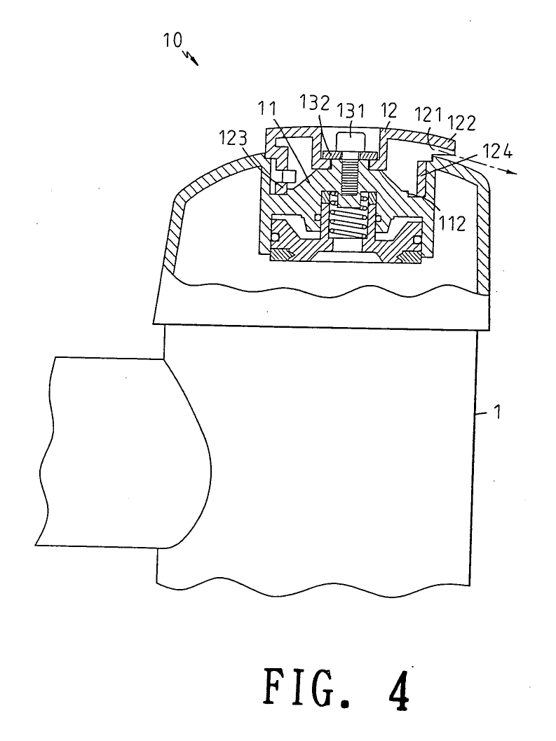

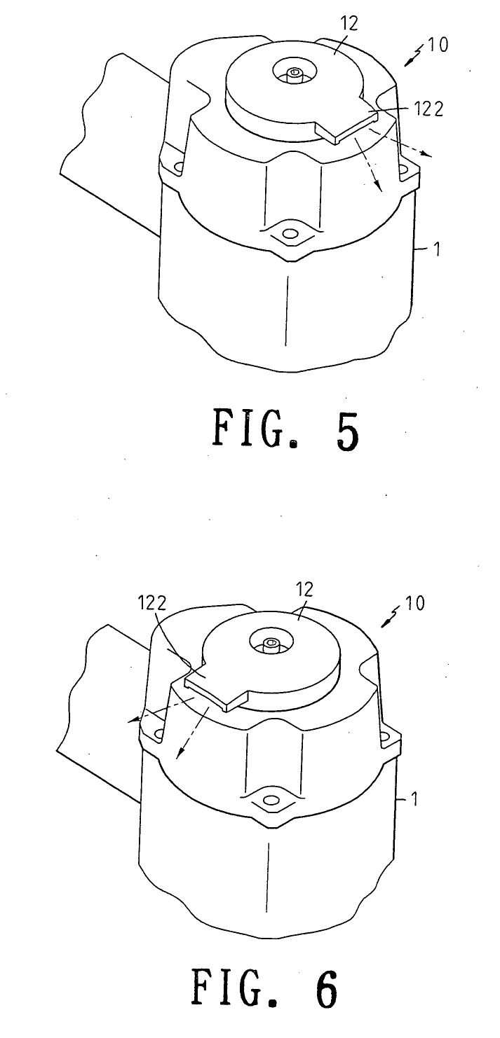

Referring to FIGS. 1 to 4, the pneumatic tool air flow guide device 10 of the present invention comprises a barrel 1 having a recess defined in a rear end thereof and the recess has a circular inner periphery thereof. A protrusion 11 is located at a center of the recess and a plurality of outlets 101 are defined through the protrusion 11 so that air is ejected out from the interior of the barrel 1 via the outlets 101. The protrusion 11 has a plurality of first flat sides 112 on an outside thereof. In this embodiment, the protrusion 11 is an octagonal protrusion and has a central threaded hole 111.

A cap 2 is rotatably connected to the rear end of the barrel 1 and has a tube extending from a top thereof. A hole 121 is defined through the tube and an extension plate 122 extends radially from a periphery of the top of the cap 2. The hole 122 is located beneath the extension plate 122. The tube has a plurality of second flat sides 123 defined in an inside thereof and the second flat sides 123 each have a slot defined therethrough.

A bolt 131 extends through a washer 132 and a central hole in the cap 12 and is threadedly connected to the threaded hole 111. The central hole is sized to receive the washer 132 therein. The neck is mounted to the protrusion 11 and the second flat sides 123 of the neck are engaged with the first flat sides 112. Rounded portions 124 are connected between adjacent second flat sides 123, wherein the number of the second flat sides 123 are three and the second flat sides 123 are located at different directions such as at positions on 0°, 90° and 180°. The rounded portions 124 are engaged with the circular inner periphery of the recess so that the tube of the cap 12 can still be rotated about the center of the protrusion 11 along the circular inner periphery of the recess to set a new position of the hole 121.

The contact areas between the first and second flat sides 112, 123 are large enough to well position the cap 12 at a desired position, so that the cap 12 is not rotated by the air flow ejected from the outlets 101.

While we have shown and described the embodiment in accordance with the present invention, it should be clear to those skilled in the art that further embodiments may be made without departing from the scope of the present invention.

What is claimed is:

1. A pneumatic tool air flow guide device comprising:
a barrel having a protrusion on a rear end thereof and a plurality of outlets defined through the protrusion, the protrusion having a plurality of first flat sides on an outside thereof, and
a cap rotatably connected to the rear end of the barrel and having a tube extending from a top thereof, a hole defined through the tube, the tube having a plurality of second flat sides defined in an inside thereof and the second flat sides being engaged with the first flat sides.

2. The device as claimed in claim 1, wherein the cap has an extension plate extending radially from a periphery of the top thereof and the hole is located beneath the extension plate.

3. The device as claimed in claim 1, wherein the protrusion has a central threaded hole and a bolt extends through the cap and is threadedly connected to the threaded hole.

4. The device as claimed in claim 1, wherein the protrusion is an octagonal protrusion.

5. The device as claimed in claim 1, wherein rounded portions are connected between adjacent second flat sides.

6. The device as claimed in claim 5, wherein the protrusion is located in a center of a recess which has a circular inner periphery and the rounded portions are engaged with the circular inner periphery.
